(19) United States
(12) Patent Application Publication
(10) Pub. No.: US 2015/0025677 A1
(43) Pub. Date: Jan. 22, 2015

(54) DEVICE FOR DETECTING GAP IN PRODUCT AND RELATED METHOD

(71) Applicant: HON HAI PRECISION INDUSTRY CO., LTD., New Taipei (TW)

(72) Inventor: TSUNG-JU CHIEN, New Taipei (TW)

(21) Appl. No.: 14/335,178

(22) Filed: Jul. 18, 2014

(30) Foreign Application Priority Data
Jul. 19, 2013 (TW) 102125853

(51) Int. Cl. B65G 47/26; B65G 43/08

(52) U.S. Cl. CPC B65G 47/261; B65G 43/08
USPC 700/230

(57) ABSTRACT

A detection device includes a transmission belt, a lifting mechanism positioned below the transmission belt, a sensor, a capturing unit, and a processor. The sensor generates a product presence signal after sensing the product within the field of view of the sensor. The capturing unit captures an image of the product in response to the product presence signal.

The processor detects whether the product is transported to first predetermined position; controls the lifting mechanism to lift the product until the product is lifted within the field of view of the sensor, acquires the captured image of the product from the capturing unit, determines whether the captured image matches a predetermined image, and controls the lifting mechanism to lower the product down to the predetermined position on the transmission belt.

### CROSS-REFERENCE TO RELATED APPLICATIONS

This application claims priority to Taiwanese Patent Application No. 102125853 filed on Jul. 19, 2013 in the Taiwan Intellectual Property Office, the contents of which are incorporated by reference herein.

### FIELD

The present disclosure relates to devices, and particularly to a detection device and a method for detecting a gap in a product.

### BACKGROUND

While testing a product, a device for detecting a gap in the product is needed.

### BRIEF DESCRIPTION OF THE DRAWINGS

FIG. 1 illustrates a diagrammatic view of a detection device.

FIG. 2 illustrates a block diagram of an embodiment of a processor of the detection device of FIG. 1.

FIG. 3 is a flowchart of an embodiment of a method implemented by the detection device of FIG. 1 for detecting a gap in a product.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

Embodiments of the present disclosure will be described with reference to the accompanying drawings.

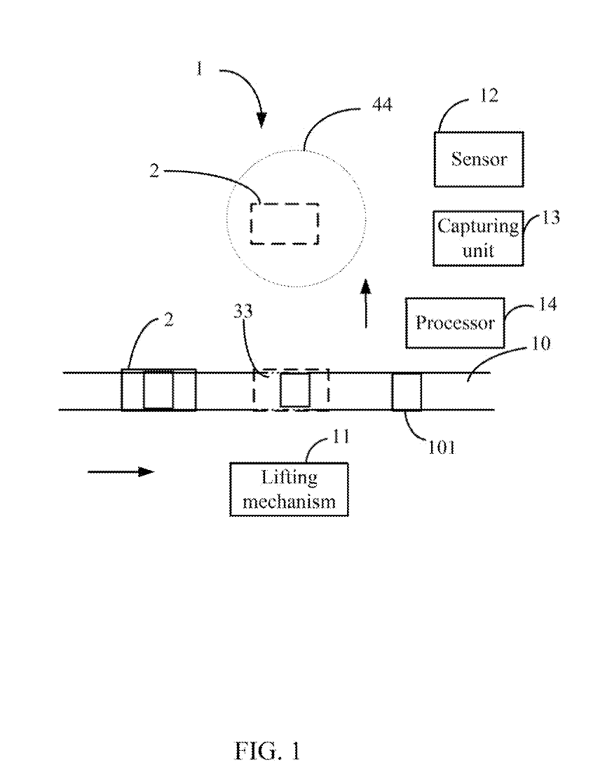

FIG. 1 illustrates an embodiment of a detection device 1 for detecting a gap in a product 2. The detection device 1 includes a transmission belt 10, a lifting mechanism 11, a sensor 12, a capturing unit 13, and a processor 14. The transmission belt 10 is used to support and transport the product 2. The lifting mechanism 11 is positioned below the transmission belt 10 and used to lift the product 2 to a predetermined height above the transmission belt 10. The sensor 12 and the capturing unit 13 are positioned at the predetermined height above the transmission belt 10. The sensor 12 generates a product presence signal after sensing the product 2 within the field of view of the sensor 12. The capturing unit 13 captures an image of the product 2 in response to the product presence signal.

The transmission belt 10 defines a number of slots 101. The product 2 can be positioned over a corresponding slot 101 on the transmission belt 10. The lifting mechanism 11 can pass through the slot 101 to lift the product 2 within the field of view of the sensor. In one embodiment, the lifting mechanism 11 is an air-pressure-operated impulsion mechanism.

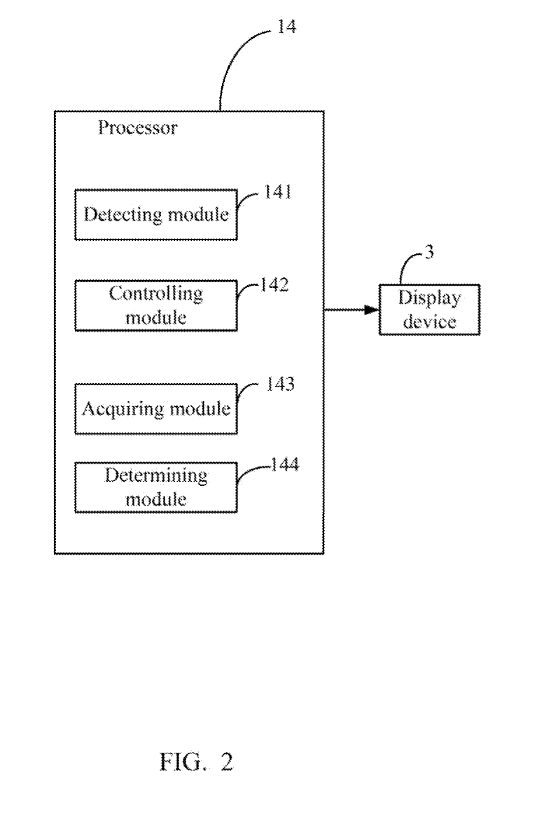

Referring to FIG. 2, the processor 14 can include a detecting module 141, a controlling module 142, an acquiring module 143, and a determining module 144.

The detecting module 141 detects whether the product 2 is transported to a predetermined position 33 on the transmission belt 10. In the predetermined position 33, the product 2 is aligned with the lifting mechanism 11. In one embodiment, the lifting mechanism 11 includes a camera, and the camera continually captures images of the transmission belt 10. The detecting module 141 compares the images captured by the lifting mechanism 11 to determine whether the product 2 is transported to the predetermined position on the transmission belt 10. When the product 2 is transported to the predetermined position, the controlling module 142 controls the lifting mechanism 11 to lift the product 2 until the product 2 is lifted within the field 44 of view of the sensor 12. The capturing unit 13 captures an image of the product 2 in response to the product presence signal. The acquiring module 143 acquires the image of the product 2 captured by the capturing unit 13. The determining module 144 determines whether the captured image matches a predetermined image in which the product 2 has no gap. The controlling module 142 controls the lifting mechanism 11 to lower the product 2 down to the predetermined position on the transmission belt 10 after the capturing unit 13 captures the image of the product 2. The controlling module 142 generates first information that there is a gap in the product 2 when the captured image does not match the predetermined image. The controlling module 142 generates second information that there is no gap in the product 2 when the captured image matches the predetermined image.

In one embodiment, the processor 14 is connected to an external display device 3. The controlling module 142 transmits the first information or the second information to the display device 3 to display. Therefore, a user can view the first or second information displayed on the display device 3 to determine whether there is a gap in the product 2.

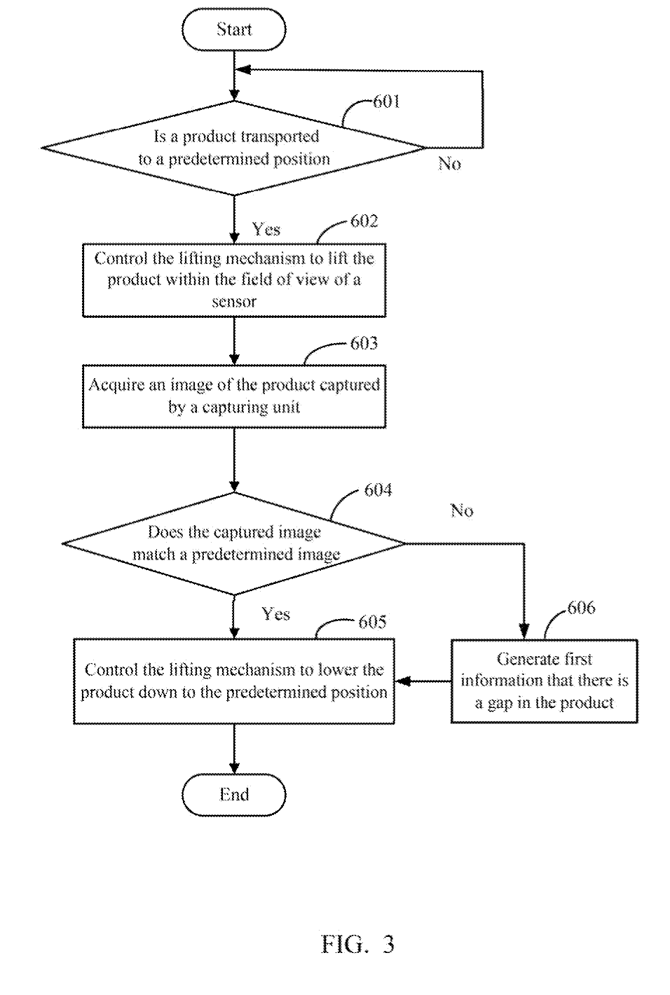

FIG. 3 is a flowchart of a method of detecting a gap on the product implemented by the detection device of FIG. 1.

In block 601, a detecting module detects whether a product on a transmission belt is transported to a predetermined position aligned with a lifting mechanism. If the product is transported to the predetermined position, block 602 is implemented. If the product is not transported to the predetermined position, block 601 is repeated.

In block 602, a controlling module controls the lifting mechanism to lift the product within the field of view of a sensor.

In block 603, an acquiring module acquires an image of the product captured by a capturing unit.

In block 604, a determining module determines whether the captured image matches a predetermined image. If the captured image matches the predetermined image, block 605 is implemented. If the captured image does not match the predetermined image, block 606 is implemented.

In block 605, the controlling module controls the lifting mechanism to lower the product down to the predetermined position on the transmission belt.

In block 606, the controlling module generates first information that there is a gap in the product 2.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A detection device for detecting a gap in a product comprising:
a transmission belt configured to support and transport the product;
a lifting mechanism positioned below the transmission belt;
a sensor positioned at a predetermined height above the transmission belt, and configured to generate a product presence signal after sensing the product within the field of view of the sensor;
a capturing unit positioned at a predetermined height above the transmission belt, and configured to capture an image of the product in response to the product presence signal; and
a processor configured to:
detect whether the product is transported to a predetermined position on the transmission belt;
control the lifting mechanism to lift the product until the product is lifted within the field of view of the sensor when the product is transported to the predetermined position on the transmission belt;
acquire the image of the product captured by the capturing unit;
determine whether the captured image matches a predetermined image in which the product has no gap; and
control the lifting mechanism to lower the product down to the predetermined position on the transmission belt when the captured image matches the predetermined image.

2. The detection device as described in claim 1, wherein the processor is further configured to generate first information that there is a gap in the product and control the lifting mechanism to lower the product down to the predetermined position on the transmission belt when the captured image does not match the predetermined image.

3. The detection device as described in claim 2, wherein the processor is connected to an external display device and further configured to transmit the first information to the display device to display.

4. The detection device as described in claim 1, wherein the transmission belt defines a plurality of slots for placing the products, the lifting mechanism is further configured to lift the product within the field of view of the sensor via the slot.

5. The detection device as described in claim 1, wherein the lifting mechanism is an air-pressure-operated impulsion mechanism.

6. A detection method for detecting a gap in a product implemented by a detection device, wherein the detection device comprises a transmission belt configured to support and transmit the product, a lifting mechanism positioned below the transmission belt, a sensor positioned at a predetermined height above the transmission belt, and configured to generate a product presence signal after sensing the product within the field of view of the sensor, and a capturing unit positioned at a predetermined height above the transmission belt, and configured to capture an image of the product in response to the product presence signal, the method comprising:
detecting whether the product is transported to a predetermined position on the transmission belt;
controlling the lifting mechanism to lift the product until the product is lifted within the field of view of the sensor when the product is transported to the predetermined position on the transmission belt;
acquiring the image of the product captured by the capturing unit;
determining whether the captured image matches a predetermined image in which the product has no gap; and
controlling the lifting mechanism to lower the product down to the predetermined position on the transmission belt when the captured image matches the predetermined image.

7. The detection method as described in claim 6, further comprising:
generating first information that there is a gap in the product; and
controlling the lifting mechanism to lower the product down to the predetermined position on the transmission belt when the captured image does not match the predetermined image.

8. The detection method as described in claim 7, further comprising:
transmitting the first information to an external display device to display.
